(19) United States
(12) Patent Application Publication
(10) Pub. No.: US 2026/0113105 A1
(43) Pub. Date: Apr. 23, 2026

(54) ELECTRONIC DEVICE FOR SUPPORTING SATELLITE COMMUNICATION, AND OPERATING METHOD THEREOF

(71) Applicant: Samsung Electronics Co., Ltd., Suwon-si, Gyeonggi-do (KR)

(72) Inventors: Hyunchul LEE, Suwon-si (KR); Yoseob KWAK, Suwon-si (KR); Haryun LEE, Suwon-si (KR); Sanghyun CHOI, Suwon-si (KR)

(21) Appl. No.: 19/426,011

(22) Filed: Dec. 18, 2025

Related U.S. Application Data
(63) Continuation of application No. PCT/KR2024/008487, filed on Jun. 19, 2024.

(30) Foreign Application Priority Data
Jul. 10, 2023 (KR) 10-2023-0089327
Aug. 22, 2023 (KR) 10-2023-0109943

(51) Int. Cl. H04B 7/185; H04W 28/02; H04W 48/08

(52) U.S. Cl. CPC H04B 7/18545; H04W 28/0263; H04W 48/08

(57) ABSTRACT

An electronic device may include a memory, a communication circuit, a communication processor, and an application processor, wherein the application processor can identify whether communication restriction information is received from the satellite network through the communication processor, if it is determined that the electronic device is registered in a satellite network; generate data filter information based on specified restriction information stored in the memory, if the communication restriction information is not received from the satellite network; generate data filter information based on the communication restriction information received from the satellite network, if the communication restriction information is received from the satellite network; and control the transmission of data to the communication processor based on the data filter information.

### CROSS-REFERENCE TO RELATED APPLICATIONS

This application is a continuation of International Application No. PCT/KR2024/008487 designating the United States, filed on Jun. 19, 2024, in the Korean Intellectual Property Receiving Office and claiming priority to Korean Patent Application Nos. 10-2023-0089327, filed on Jul. 10, 2023, and 10-2023-0109943, filed on Aug. 22, 2023, in the Korean Intellectual Property Office, the disclosures of each of which are incorporated by reference herein in their entireties.

### BACKGROUND

### Field

The disclosure relates to an electronic device supporting satellite communication and an operation method thereof.

### Description of Related Art

A wireless communication system may provide wireless connections to electronic devices to enable wireless communication between various electronic devices. A wireless communication system may provide wireless communication between electronic devices by allocating radio frequency resources to the electronic devices through the control of a base station installed on the ground. Due to the physical limitation that a base station is installed on the ground, a wireless communication system may have difficulty in providing a wireless connection for electronic devices located in the ocean and/or in the airspace above a certain altitude.

A wireless communication system is evolving to include a satellite network and a terrestrial network to address the physical limitations of a base station located on the ground, and to expand the range of providing wireless connection of electronic devices to a global scale. A wireless communication system may include a terrestrial network and a satellite network, thereby providing wireless communication with an electronic device even in a region where it is difficult to construct a terrestrial network or in a disaster situation.

The satellite network may communicate with a terrestrial network (e.g., a core network) through a terrestrial gateway by utilizing at least one satellite. However, the satellite network may have limited communication capabilities for multiple electronic devices due to the limitations of satellite communication caused by the signal latency between the satellite and the electronic device and the movement of the satellite. The satellite network may provide the electronic device with a limited communication function (e.g., an emergency message function) that is determined to be available to the electronic device through satellite communication among communication functions (e.g., data communication) supported by the electronic device.

If the electronic device is unable to be aware of information related to the limited communication functions of the satellite network, the electronic device may transmit signals (or data) related to communication functions not supported by the satellite network to the satellite network. Communication functions not supported by the satellite network may be filtered and limited in the satellite network. Power (or current) and radio resources may be unnecessarily consumed by transmitting, from the electronic device, signals (or data) related to communication functions that are not supported in the satellite network.

### SUMMARY

Embodiments of the disclosure provide a device and a method for reducing power and radio resource consumption for satellite communication in an electronic device.

According to an example embodiment, the electronic device may include: a memory, a communication circuit configured to support satellite communication, at least one communication processor, comprising processing circuitry, and at least one application processor, comprising processing circuitry, wherein at least one application processor, individually and/or collectively, may be configured to cause the electronic device to: identify whether communication restriction information is received from the satellite network through at least one communication processor based on determining that the electronic device is registered in the satellite network; generate data filter information, based on specified restriction information stored in the memory of the electronic device based on the communication restriction information not being received from the satellite network; generate data filter information, based on the communication restriction information received from the satellite network, based on the communication restriction information being received from the satellite network; and control data transmission to at least one communication processor, based on data filter information.

According to an example embodiment, a method of operating an electronic device may include: identifying, by at least one application processor of the electronic device, whether communication restriction information is received from the satellite network through at least one communication processor of the electronic device based on determining that the electronic device is registered in a satellite network; generating data filter information, based on specified restriction information stored in the electronic device, based on the communication restriction information not being received from the satellite network; generating data filter information, based on the communication restriction information received from the satellite network, based on the communication restriction information being received from the satellite network; and controlling data transmission to the communication processor, based on the data filter information.

According to an example embodiment, a non-transitory computer-readable storage medium (or a computer program product) storing one or more programs is provided. According to an example embodiment, the one or more programs may include instructions that, when executed by at least one processor, comprising processing circuitry, of an electronic device, individually and/or collectively, cause the electronic device to perform operations including: identifying, by at least one application processor of the electronic device, whether communication restriction information is received from a satellite network through at least one communication processor of the electronic device based on determining that the electronic device is registered in the satellite network, generating data filter information, based on specified restriction information stored in the electronic device, based on the communication restriction information not being received from the satellite network, generating data filter information, based on the communication restriction information received from the satellite network, based on the communication restriction information being received from the satellite network, and controlling data transmission to the communication processor, based on the data filter information.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various embodiments.

FIG. 2 is a diagram illustrating an example configuration of an electronic device and a long-range communication network environment according to various embodiments.

FIG. 3 is a block diagram illustrating an example configuration of an electronic device supporting satellite communication according to various embodiments.

FIG. 4 is a block diagram illustrating an example configuration of an application processor in an electronic device according to various embodiments.

FIG. 5 is a flowchart illustrating example operations for filtering data communication in an electronic device according to various embodiments.

FIG. 6 is a signal flow diagram illustrating an example of filtering data communication in an electronic device according to various embodiments.

FIG. 7 is a signal flow diagram illustrating an example for acquiring communication restriction information in an electronic device according to various embodiments.

FIG. 8 is a flowchart illustrating example operations for updating filter information related to data communication in an electronic device according to various embodiments.

### DETAILED DESCRIPTION

Hereinafter, various example embodiments will be described in greater detail reference to the attached drawings.

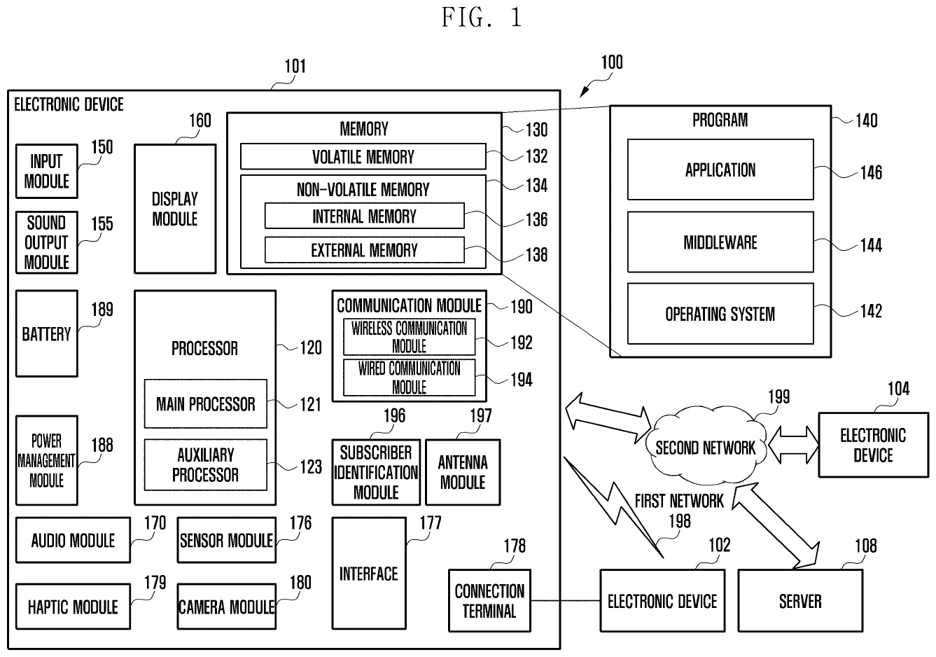

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs 35 other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC. According to an embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form high frequency (e.g., a mm Wave) antenna module. According to an embodiment, the high frequency (e.g., the mmWave) antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include patch array antennas and/or dipole array antennas. For example, the plural antennas may include patch array antennas and/or dipole array antennas.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

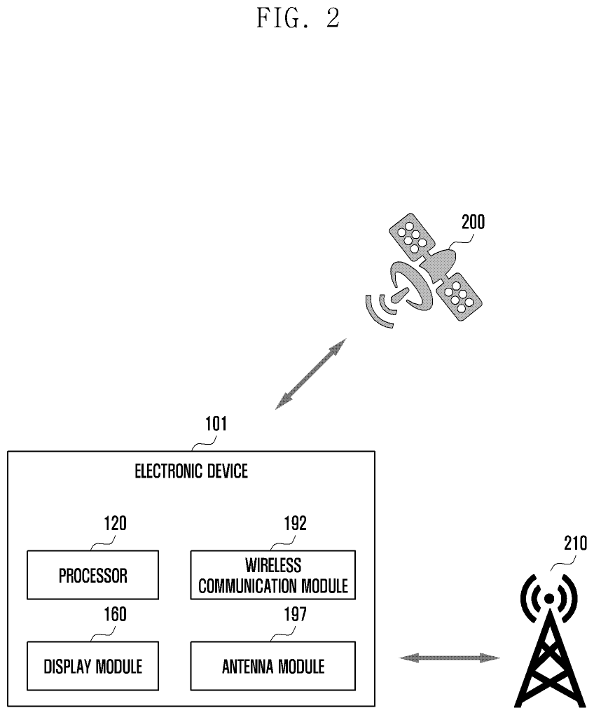

FIG. 2 is a block diagram illustrating an example configuration of an electronic device and a long-range communication network environment according to various embodiments.

According to an embodiment referring to FIG. 2, the electronic device (e.g., the electronic device 101 of FIG. 1) may perform at least one of transmission or reception of data through at least one of a terrestrial network or a non-terrestrial network.

The terrestrial network may refer to a network capable of providing data communication through a terrestrial wireless communication device 210. For example, the terrestrial wireless communication device 210 may include a base station located on the ground (e.g., a base station fixed to the ground). The terrestrial wireless communication device 210 may support at least one communication method among various communication methods (e.g., 3^{rd} generation (3G), 4G, and 5G) supported by the electronic device 101. For example, the terrestrial wireless communication device 210 may include an eNodeB (eNB) or a gNodeB (gNB), but is not limited to the types thereof.

The non-terrestrial network may refer to a network (or a satellite network) capable of providing data communication through at least one non-terrestrial wireless communication device 200. For example, the non-terrestrial wireless communication device 200 may include at least one of various communication devices such as a base station and a relay station that is not located on the ground. For example, the non-terrestrial wireless communication device 200 may include at least one of a satellite or an unmanned aerial vehicle, but is not limited to the type thereof. For example, the satellite may include at least one of a low-earth orbit (LEO) satellite, a medium-earth orbit (MEO) satellite, a geostationary earth orbit (GEO) satellite, or a high elliptical orbit (HEO) satellite. For example, the satellite may include a mobile satellite and/or a geostationary satellite.

The non-terrestrial wireless communication device 200 may support at least one of various wireless communication methods. For example, the non-terrestrial wireless communication device 200 may support a non-terrestrial network (NR NTN) defined by the 3rd Generation Partnership Project (3GPP). Alternatively, the non-terrestrial wireless communication device 200 may support at least one of communication methods based on various communication standards such as LTE, global system for mobile communications (GSM), or code-division multiple access (CDMA), but the type is not limited thereto.

The terrestrial network and the non-terrestrial network may be mutually independent networks. Alternatively, the terrestrial network and the non-terrestrial network may be included in at least one network (e.g., a network provided by the same operator) that is associated with each other.

The electronic device 101 may perform wireless communication through the non-terrestrial network when communication with the terrestrial network is impossible or when communication with the terrestrial network is not smooth. Alternatively, the electronic device 101 may perform wireless communication through the non-terrestrial network regardless of the communication state with the terrestrial network.

According to an embodiment, the electronic device 101 may include at least one of a processor (e.g., including processing circuitry) 120, a display module (e.g., including a display) 160, a wireless communication module (or wireless communication circuitry) 192 (e.g., a communication circuit), and/or an antenna module (e.g., including at least one antenna) 197. For example, the processor 120 may be operatively, functionally, or electrically connected to at least one of the display module 160, the wireless communication module 192, or the antenna module 197.

According to an embodiment, the processor 120 may include various processing circuitry and control overall operations related to at least one of terrestrial network communication or non-terrestrial network communication. For example, the processor 120 may include a communication processor (e.g., the auxiliary processor 123 of FIG. 1) related to at least one of terrestrial network communication or non-terrestrial network communication. The description of the processor 120 above with reference to FIG. 1 applies equally here and may not be repeated.

According to an embodiment, the display module 160 may include a display and visually provide information processed by the electronic device 101 (e.g., the processor 120 or the wireless communication module 192). For example, the display module 160 may display a user interface (UI) (or a graphic user interface (GUI)) related to the terrestrial network and/or the non-terrestrial network. For example, the user interface may include at least one of a network type (e.g., cellular communication (3G, 4G, or 5G), short-range communication (e.g., BT or Wi-Fi), or satellite communication), a type of network service provider (e.g., a satellite communication service provider), an emergency service provider (ESP), a network signal strength (e.g., signal strength bars, a received signal strength indicator (RSSI), or a reference signal received power (RSRP)), a direction (e.g., an orientation, an elevation angle, or an azimuth angle) of a communication device (e.g., a satellite) included in the network, presence information, or a network communication state (e.g., idle, transmit, or receive).

For example, the user interface indicating information related to at least one of the terrestrial network or the non-terrestrial network may include information related to at least one of service information related to at least one of the terrestrial network or the non-terrestrial network (e.g., an emergency messaging service), government office information, emergency contact information, common phrases that minimize and/or reduce user text input, questionnaires for rapid emergency communication (e.g., guidance information such as the type of accident, location of injury, or medical information), a messaging service (e.g., small message service (SMS), multimedia message service (MMS), or rich communication service (RCS) messages), voice calls, video calls, a data communication service (e.g., information on various applications that provide data communication, including Internet browser apps), a location sharing service (e.g., longitude/latitude coordinates, location-related map information for the non-terrestrial communication devices 200, navigation, or street view), and user interfaces related to dialers or indicators. For example, the emergency message transmission service may include a series of operations for displaying SOS service state information related to whether an SOS service is provided. For example, the medical information may include at least one of age, gender, disease information, or medication information.

For example, a user interface indicating information related to at least one of a terrestrial network or a non-terrestrial network is not limited to the example described above and may be provided through another output device (e.g., the sound output module 155 of FIG. 1).

According to an embodiment, the wireless communication module 192 may include various communication circuitry and support various types of wireless communication bands supported by the electronic device 101. For example, the wireless communication band may include at least one of a short-range wireless communication band (e.g., Bluetooth (BT), Bluetooth low energy (BLE), or Wi-Fi), a terrestrial network (e.g., a cellular network) communication band, or a non-terrestrial network (NTN) band (e.g., n255 band and/or n256 band). For example, the wireless communication band supported by the electronic device 101 may not be limited to the example described above.

For example, the wireless communication module 192 may perform non-terrestrial network wireless communication using at least a part of a frequency band related to terrestrial network wireless communication.

According to an embodiment, the antenna module 197 may include at least one antenna and perform wireless communication with the non-terrestrial network using at least one antenna among a plurality of antennas included in the antenna module 197. For example, at least one antenna supporting wireless communication with the non-terrestrial network may include a dedicated antenna and/or a combination antenna. For example, the dedicated antenna may include an antenna supporting the non-terrestrial network. For example, the combination antenna may include an antenna that supports a non-terrestrial network and a different kind of network together. For example, the combination antenna may include an antenna supporting a short-range communication network (e.g., a Bluetooth network, or a wireless LAN network) and/or a terrestrial network (e.g., a long term evolution (LTE) network or a new radio (NR) network).

For example, the electronic device 101 may communicate with at least one satellite (e.g., a GNSS satellite or a satellite for emergency message service) using at least one non-terrestrial network (NTN) dedicated antenna. For example, the electronic device 101 may support wireless communication with the non-terrestrial network using a plurality of antennas among the antennas supporting the terrestrial network.

Hereinafter, in the disclosure, the non-terrestrial wireless communication device 200 may be referred to as a satellite, and although the satellite is referred to as providing wireless communication based on a specific radio access technology (RAT) (e.g., LTE and/or NR) or a specific function (e.g., a base station), this is an example and the type is not limited, which may be easily understood by those skilled in the art.

In the following description, data communication may include a series of operations that perform at least one of transmission or reception of data through at least one of the default EPS bearer or dedicated EPS bearer defined in the long-term evolution (LTE) standard or an Internet packet data network (PDN) defined in the new radio (NR) standard and/or Internet protocol (IP) multimedia subsystem (IMS) PDN.

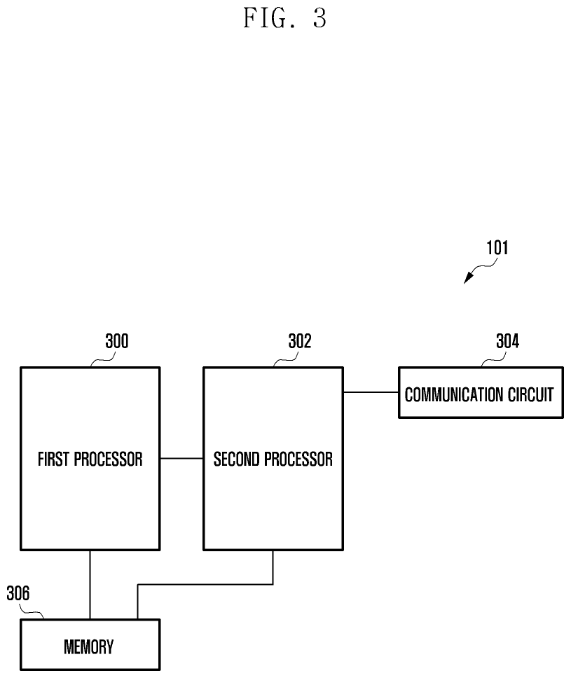

FIG. 3 is a block diagram illustrating an example configuration of an electronic device supporting satellite communication according to various embodiments. For example, the electronic device 101 of FIG. 3 may include the electronic device 101 of FIGS. 1 and 2.

According to an embodiment referring to FIG. 3, the electronic device 101 may include at least one of a first processor (e.g., including processing circuitry) 300, a second processor (e.g., including processing circuitry) 302, a communication circuit (or communication circuitry) 304, and/or a memory 306. For example, the first processor 300 may be substantially the same as the processor 120 or the main processor 121 (e.g., an application processor) of FIG. 1 or include the processor 120 or the main processor 121. For example, the second processor 302 may be substantially the same as the processor 120 or the auxiliary processor 123 (e.g., a communication processor) of FIG. 1 or include the processor 120 or the auxiliary processor 123. Thus, the descriptions above of the processors 120, 121 and 123 with reference to FIG. 1 apply equally to the processors 300, 302 and thus a description may not be repeated here. For example, the communication circuit 304 may be substantially the same as the wireless communication module 192 of FIG. 1 or may include the wireless communication module 192. For example, the memory 320 may be substantially the same as the memory 130 of FIG. 1 or may include the memory 130. For example, the first processor 300 may be operatively, functionally, or electrically connected to at least one of the second processor 302 or the memory 306. For example, the first processor 300 may include at least one processor including a processing circuit. For example, the second processor 302 may be operatively, functionally, or electrically connected to at least one of the first processor 300, the communication circuit 304, or the memory 306. For example, the second processor 302 may include at least one processor including a processing circuit.

According to an embodiment, the second processor 302 may include various processing circuitry and control the communication circuit 304 to register the electronic device 101 in a satellite network. For example, registration in the satellite network may include a series of operations for registration in the satellite network (or core network) through a satellite (e.g., the non-terrestrial wireless communication device 200 of FIG. 2) to which the electronic device 101 is connected. For example, in case that a satellite accessible by the electronic device 101 is detected, the second processor 302 may control the communication circuit 304 to perform a random access channel (RACH) procedure for access to the satellite. For example, the RACH procedure may include a series of operations in which the electronic device 101 transmits a RACH preamble to the satellite and receives a RACH response (e.g., RAR) message from the satellite, and a series of operations in which the electronic device 101 transmits a radio resource control (RRC) connection request message to the satellite and receives an RRC connection setup message from the satellite. For example, detection of a satellite (e.g., the non-terrestrial wireless communication device 200 of FIG. 2) may include a series of operations in which a signal exceeding a specified signal quality from the satellite is received. For example, the signal quality may include at least one of a received signal strength indicator (RSSI), a reference signal received quality (RSRQ), a reference signal received power (RSRP), a signal to interference and noise ratio (SINR), or a bit error rate (BER).

For example, the second processor 302 may include various processing circuitry and control the communication circuit 304 to register in the satellite network through a satellite (e.g., the non-terrestrial wireless communication device 200 of FIG. 2) to which the electronic device 101 is connected. For example, registration in the satellite network may include a series of operations in which the electronic device 101 transmits an attach request message through a satellite and receives an attach accept message from the satellite.

For example, when the network information acquired from the network in which the electronic device 101 is registered is included in the specified public land mobile network (PLMN) information, the second processor 302 may determine that the electronic device 101 is registered in the satellite network. For example, the network information may include at least one of a mobile country code (MCC) or a mobile network code (MNC). For example, the specified PLMN information may include information related to the satellite network.

For example, the second processor 302 may identify the registration to the satellite network, based on control information (e.g., a system information block (SIB)) acquired (or received) from the registered network in which the electronic device 101 is registered.

For example, when the second processor 302 has identified the registration to the satellite network, the second processor 302 may transmit information related to the registration to the satellite network to the first processor 300.

According to an embodiment, the first processor 300 may identify data filter information related to the satellite network when it is determined that the electronic device 101 is registered in the satellite network. For example, when the first processor 300 acquires information related to registration in the satellite network from the second processor 302, the first processor 300 may determine that the electronic device 101 is registered in the satellite network. When it is determined that the electronic device 101 is registered in the satellite network, the first processor 300 may identify whether there is communication restriction information acquired from the satellite network. For example, the communication restriction information acquired from the satellite network may be acquired through the second processor 302.

For example, when there is no communication restriction information acquired from the satellite network, the first processor 300 may generate data filter information related to the satellite network, based on the specified communication restriction information. For example, the satellite network-related data filter information relates to a communication function determined to be supported by the satellite network and may be used to filter signals (or data) transmitted to the satellite network. For example, the specified communication restriction information is communication restriction information stored in the memory 306, and may include at least one of communication restriction information configured at the time of release of the electronic device 101 or communication restriction information acquired from the satellite network at a previous time.

For example, when there is communication restriction information acquired from the satellite network, the first processor 300 may generate data filter information related to the satellite network, based on the communication restriction information acquired from the satellite network. For example, the data filter information may include information related to at least one of the data type determined to be supported in the satellite network or the types of communication functions. For example, at least one of the data type supported in the satellite network or the types of communication functions may be identified based on at least one of a port (e.g., a port or a local port) related to data transmission, an IP version (e.g., IPv4 or IPv6), or an Internet Protocol (IP) address.

According to an embodiment, the first processor 300 may update data filter information related to the satellite network. For example, when the first processor 300 generates data filter information related to the satellite network based on the specified communication restriction information, the first processor 300 may identify whether the communication restriction information is received from the satellite network. When the first processor 300 acquires the communication restriction information received from the satellite network through the second processor 302, the first processor 300 may update data filter information based on the communication restriction information received from the satellite network. For example, when the first processor 300 acquires update information related to the communication restriction from the second processor 302, the first processor 300 may update data filter information based on the update information related to the communication limitations.

According to an embodiment, the first processor 300 may filter signals (or data) to be transmitted to the satellite network based on data filter information. For example, the first processor 300 may identify whether the corresponding signal (or data) is transmittable to the satellite network based on at least one of the type of the signal (or data) to be transmitted to the satellite network or the type of the communication function. For example, at least one of the type of the signal (or data) to be transmitted to the satellite network or the type of the communication function may be identified, based on at least one of a port or an IP address related to the signal (or data) to be transmitted to the satellite network.

For example, when the first processor 300 determines that the corresponding signal (or data) is transmissible to the satellite network, the first processor 300 may transmit the signal (or data) for transmission to the satellite network to the second processor 302. For example, when the transmission of the signal (or data) to the satellite network is limited, the first processor 300 may limit the transmission of the signal (or data).

According to an embodiment, when the second processor 302 has acquired communication restriction information or update information related to the communication restriction from the satellite network, the second processor 302 may provide the communication restriction information or the update information related to the communication restriction to the first processor 300. For example, the second processor 302 may modify, in correspondence with the first processor 300, at least one of the communication restriction information or the update information related to the communication restriction acquired from the satellite network, and provide (or transmit) the same to the first processor 300. For example, the communication restriction information may include a traffic filter template (TFT) received from the satellite network.

According to an embodiment, when the second processor 302 has acquired (or received) a signal (or data) for transmission to the satellite network from the first processor 300, the second processor 302 may control the communication circuit 304 to transmit the corresponding signal (or data) to the satellite network. According to an embodiment, when the second processor 302 has not acquired (or received) a signal (or data) for transmission to the satellite network from the first processor 300, the second processor 302 may operate in an inactive state. The second processor 302 may operate in (or switch to) an active state when the second processor 302 has acquired (or received) a signal (or data) for transmission to the satellite network from the first processor 300 in an inactive state. For example, the inactive state of the second processor 302 is a state in which the operation of the second processor 302 is limited or suspended, and power (or current) consumption of the second processor 302 is minimized and/or reduced, and may include a low power state (e.g., a sleep state) or a standby state (e.g., an idle state).

According to an embodiment, the communication circuit 304 may support the electronic device 101 in performing at least one of transmission or reception of at least one of a signal or data with an external device (e.g., the electronic device 102 or 104 or the server 108 of FIG. 1) related to satellite communication.

According to an embodiment, the memory 306 may store various data used by at least one component (e.g., the first processor 300, the second processor 302, or the communication circuit 304) of the electronic device 101. For example, the data stored in the memory 306 may include specified communication restriction information related to data filter information. For example, the memory 306 may store various instructions executable through at least one of the first processor 300 and the second processor 302.

According to an embodiment, the electronic device 101 (e.g., the second processor 302) may acquire at least one of communication restriction information related to the satellite network or update information related to communication restriction from the terrestrial network.

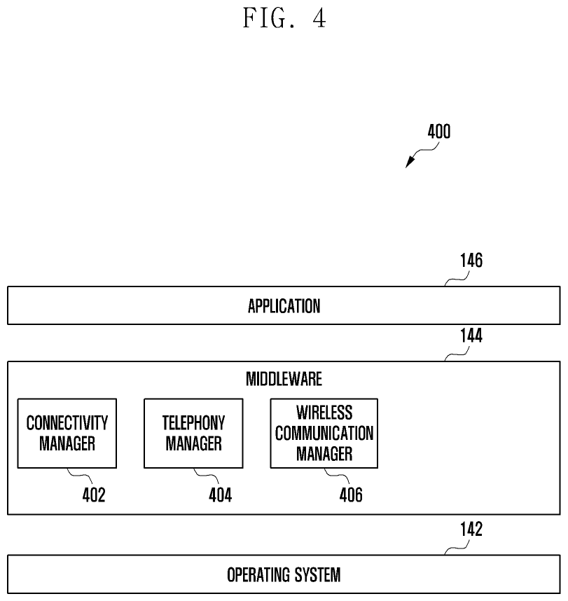

FIG. 4 is a block diagram 400 illustrating an example program according to various embodiments.

According to an embodiment referring to FIG. 4, the program 140 may include data or instructions stored in the memory 130 and may include an operating system (OS) 142, middleware 144, and/or an application 146 executable in the OS 142. The program 140 may be executed by an application processor (e.g., the first processor 300 of FIG. 3).

According to an embodiment, the operating system 142 may control the management (e.g., allocation or reclamation) of one or more system resources (e.g., processes, memory, or power) of the electronic device 101. According to an embodiment, the operating system 142 may include one or more driver programs for operating other hardware devices (e.g., the second processor 302 or the communication circuit 304) of the electronic device 101.

According to an embodiment, the operating system 142 may include a kernel. For example, the kernel may filter a signal (or data) to be transmitted to the satellite network, based on the data filter information acquired from the radio communication manager 406 of the middleware 144. For example, the kernel may identify whether the signal (or data) may be transmitted to the satellite network based on at least one of the type of the signal (or data) to be transmitted to the satellite network or the type of the communication function provided from at least one of the application 146 or the middleware 144. For example, at least one of the type of the signal (or data) to be transmitted to the satellite network or the type of the communication function may be identified based on at least one of a port or an IP address related to the signal (or data) for transmission to the satellite network.

For example, when the kernel determines that the corresponding signal (or data) is transmittable to a satellite network, the kernel may transmit a signal (or data) for transmission to the satellite network to the second processor 302. For example, when the transmission of the corresponding signal (or data) to the satellite network is limited, the kernel may limit the transmission of the corresponding signal (or data).

According to an embodiment, the middleware 144 may provide various functions to the application 146 so that functions or information provided from one or more resources of the electronic device 101 may be used by the application 146. For example, the middleware 144 may include a connectivity manager 402, a telephony manager 404, or a wireless communication manager 406.

According to an embodiment, the connectivity manager 402 may manage a wireless connection or a direct connection between the electronic device 101 and an external electronic device. According to an embodiment, the telephony manager 404 may manage a voice call function or a video call function provided by the electronic device 101.

According to an embodiment, the wireless communication manager 406 may manage data filter information related to the satellite network. For example, when the wireless communication manager 406 determines that the electronic device 101 is registered in the satellite network, the wireless communication manager 406 may identify whether there is communication restriction information acquired from the satellite network. For example, the communication restriction information acquired from the satellite network may be acquired through the second processor 302. For example, the wireless communication manager 406 may include a radio interface layer (RIL).

For example, when there is no communication restriction information acquired from the satellite network, the wireless communication manager 406 may generate data filter information related to the satellite network, based on the specified communication restriction information. For example, the specified communication restriction information is communication restriction information stored in the memory 306, and may include at least one of communication restriction information configured at the time of release of the electronic device 101 or communication restriction information acquired from the satellite network at a previous time.

For example, when there is communication restriction information acquired from the satellite network, the wireless communication manager 406 may generate data filter information related to the satellite network, based on the communication restriction information acquired from the satellite network. For example, the data filter information may include information related to at least one of the data type determined to be supported in the satellite network or the types of communication functions. For example, at least one of the data type supported in the satellite network or the types of communication functions may be identified based on at least one of a port (e.g., a port or a local port) related to data transmission or an Internet Protocol (IP) address. For example, at least one of the type of data determined to be supported by the satellite network or the type of communication function may include at least one of an emergency message function, a short message service (SMS), or a multimedia message service (MMS).

According to an embodiment, the wireless communication manager 406 may update data filter information related to the satellite network. For example, when the wireless communication manager 406 has generated data filter information related to the satellite network based on the specified communication restriction information, the data filter information may be updated based on the communication restriction information received from the satellite network. For example, when the wireless communication manager 406 receives update information related to communication restriction from the satellite network, the data filter information may be updated based on the update information related to the communication restriction. For example, the update information related to the communication restriction may be acquired from the second processor 302.

According to an embodiment, the middleware 144 may dynamically delete a part of existing components or add new components. According to an embodiment, at least a part of the middleware 144 may be included as a part of the operating system 142 or implemented as software different from the operating system 142.

According to an embodiment, the application 146 may include at least one application program related to a function provided by the electronic device 101.

According to an example embodiment, the electronic device (e.g., the electronic device 101 of FIG. 1, FIG. 2, FIG. 3, or FIG. 4) may include memory (e.g., the memory 130 of FIG. 1 or the memory 306 of FIG. 3), a communication circuit (e.g., the wireless communication module 192 of FIG. 1 or the communication circuit 304 of FIG. 3) supporting satellite communication, at least one communication processor (e.g., the processor 120, the auxiliary processor 123 of FIG. 1, or the second processor 302 of FIG. 3) comprising processing circuitry, and at least one application processor (e.g., the processor 120, the main processor 121 of FIG. 1, or the first processor 300 of FIG. 3) comprising processing circuitry. According to an embodiment, when the electronic device is determined to be registered in the satellite network, the at least one application processor may identify whether communication restriction information has been received from the satellite network through the at least one communication processor. According to an embodiment, when the at least one application processor has not received the communication restriction information from the satellite network, the at least one application processor may generate data filter information based on the specified restriction information stored in the memory of the electronic device. According to an embodiment, when the at least one application processor has received the communication restriction information from the satellite network, the at least one application processor may generate data filter information based on the communication restriction information received from the satellite network. According to an embodiment, the at least one application processor may control data transmission to the at least one communication processor based on the data filter information.

According to an embodiment, the at least one communication processor may perform registration in the satellite network. According to an embodiment, if it is determined that the electronic device is registered in the satellite network, the at least one communication processor may transmit information related to registration in the satellite network to the at least one application processor. According to an embodiment, the at least one application processor may determine that the electronic device is registered in the satellite network based on the information related to registration in the satellite network received from the at least one communication processor.

According to an embodiment, when the at least one application processor has not received the communication restriction information from the satellite network through the at least one communication processor, the at least one application processor may control data transmission to the at least one communication processor based on data filter information generated, based on the specified communication restriction information.

According to an embodiment, the data filter information may include information related to at least one of at least one data port or at least one Internet protocol (IP) allowing transmission to the satellite network.

According to an embodiment, the at least one application processor may identify at least one of a port or an Internet protocol (IP) of data to be transmitted to the satellite network. According to an embodiment, the at least one application processor may identify whether the data is transmitted based on at least one of the port or the IP of the data and the data filter information. According to an embodiment, if the at least one application processor determines that the data is to be transmitted, the at least one application processor may transmit the data to the at least one communication processor.

According to an embodiment, when it is determined that the data is not to be transmitted, the at least one application processor may limit transmission of the data to the at least one communication processor.

According to an embodiment, the at least one communication processor may edit communication restriction information acquired from a control message received from the satellite network through the communication circuit to correspond to the at least one application processor and transmit the same to the at least one application processor.

According to an embodiment, the at least one application processor may control data transmission to the at least one communication processor through a kernel based on data filter information.

According to an embodiment, when the at least one application processor generates data filter information based on the specified limitation information, the at least one application processor may identify whether communication limitation information has been received from the satellite network through the at least one communication processor. According to an embodiment, when the at least one application processor has received communication restriction information from the satellite network, the at least one application processor may update the data filter information based on the communication restriction information received from the satellite network. According to an embodiment, the at least one application processor may control data transmission to the at least one communication processor based on the updated data filter information, based on the communication restriction information received from the satellite network.

According to an embodiment, when the at least one application processor has received update information related to communication restrictions from the satellite network through the at least one communication processor while being registered in the satellite network, the at least one application processor may update the data filter information based on the update information related to the communication restrictions and control data transmission to the at least one communication processor based on the updated data filter information.

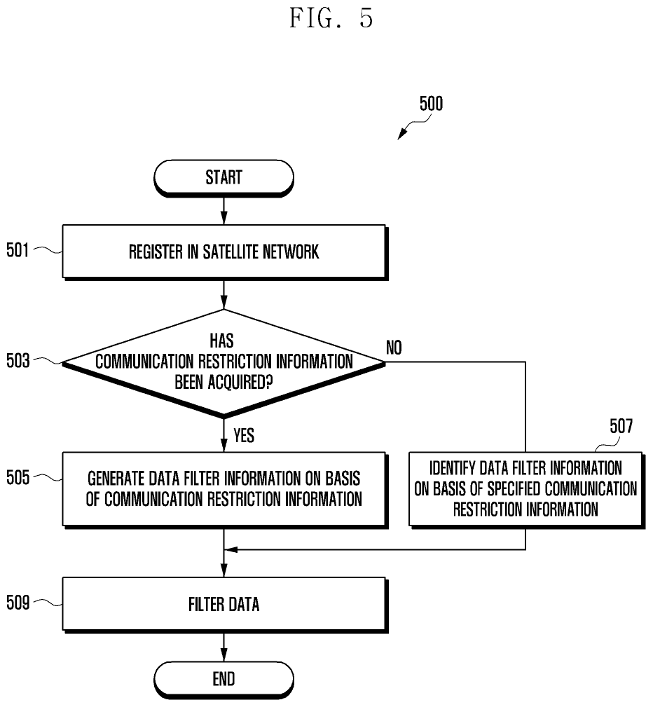

FIG. 5 is a flowchart 500 illustrating example operations for filtering data communication in an electronic device according to various embodiments. Each operation in the following embodiments may be performed in sequence, but is not necessarily performed in sequence. For example, the order of the operations may be changed, and at least two operations may be performed in parallel. For example, the electronic device of FIG. 5 may be the electronic device 101 of FIG. 1, FIG. 2, FIG. 3, or FIG. 4.

According to an embodiment referring to FIG. 5, in operation 501, the electronic device (e.g., the processor 120 of FIG. 1 or the second processor 302 of FIG. 3) may register in a satellite network. For example, when a satellite (e.g., the non-terrestrial wireless communication device 200 of FIG. 2) accessible by the electronic device 101 through a satellite-related search is detected, the second processor 302 may control the communication circuit 304 to perform access to the satellite (e.g., the non-terrestrial wireless communication device 200 of FIG. 2) through a random access channel (RACH) procedure. For example, the RACH procedure may include a series of operations in which the electronic device 101 transmits a RACH preamble to the satellite and receives a RACH response (e.g., RACH response (RAR)) message from the satellite, and a series of operations in which the electronic device 101 transmits an RRC connection request message to the satellite and receives an RRC connection setup message from the satellite. For example, detecting a satellite may include a series of operations for receiving a signal exceeding a specified signal quality (e.g., RSSI) from the satellite.

For example, the second processor 302 may control the communication circuit 304 to register the electronic device 101 in the satellite network through the satellite to which the electronic device 101 is connected. For example, registration in the satellite network may include a series of operations in which the electronic device 101 transmits an attach request message through the satellite and receives an attach accept message from the satellite.

For example, if the information on the network in which the electronic device 101 is registered is included in the specified public land mobile network (PLMN) information, the second processor 302 may determine that the electronic device 101 is registered in the satellite network. For example, the network information may include at least one of a mobile country code (MCC) or a mobile network code (MNC). For example, the specified PLMN information may include information related to the satellite network. For example, the second processor 302 may identify registration in the satellite network based on control information (e.g., system information block (SIB)) acquired (or received) from the network in which the electronic device 101 is registered.

For example, when the second processor 302 has identified the registration in the satellite network, the second processor 302 may transmit information related to the registration in the satellite network to the first processor 300. When the first processor 300 acquires information related to registration in the satellite network from the second processor 302, the first processor 300 may determine that the electronic device 101 is registered in the satellite network.

According to an embodiment, in operation 503, the electronic device (e.g., the processor 120 or the first processor 300) may identify whether the electronic device 101 has acquired communication restriction information from the satellite network in which the electronic device 101 is registered. For example, if the second processor 302 receives communication restriction information from the satellite network in which the electronic device 101 is registered, the second processor 302 may transmit information related to the communication restriction information to the first processor 300. For example, the communication restriction information may include a traffic filter template (TFT) acquired from the satellite network through “Default EPS Bearer context” information.

According to an embodiment, when the electronic device (e.g., the processor 120 or the first processor 300) has acquired the communication restriction information from the registered satellite network in which the electronic device 101 is registered (e.g., “Yes” in operation 503), in operation 505, the electronic device 101 may generate data filter information related to the satellite network based on the communication restriction information acquired from the satellite network. For example, the satellite network-related data filter information relates to a communication function determined to be supported by the satellite network and may be used to filter signals (or data) transmitted to the satellite network.

According to an embodiment, when the electronic device (e.g., the processor 120 or the first processor 300) has not acquired the communication restriction information from the registered satellite network in which the electronic device 101 is registered (e.g., “No” in operation 503), in operation 507, the electronic device 101 may generate data filter information related to the satellite network based on the specified communication restriction information. For example, the specified communication restriction information is communication restriction information stored in the memory 306, and may include at least one of communication restriction information configured at the time of release of the electronic device 101 or communication restriction information acquired from the satellite network at a previous time. For example, the data filter information may include information related to at least one of the data type determined to be supported in the satellite network or the types of communication functions. For example, at least one of the data type supported in the satellite network or the types of communication functions may be identified based on at least one of a port (e.g., a port or a local port) related to data transmission, an IP version (e.g., IPv4 or IPv6), or an Internet Protocol (IP) address (e.g., destination IP). For example, data filter information related to the satellite network may be configured as in Table 1 below.

TABLE 1

| Packet | IP | Local | | Destination |
|---|---|---|---|---|
| filter ID | version | Port | Destination IP | Port |
| 0 | IPv6 | 1235 | 2a00:809:400:59::6 | 30013 |
| 1 | IPv6 | 7777 | 2a00:809:400:59::6 | 30012 |

According to an embodiment, in operation 509, the electronic device (e.g., the processor 120 or the first processor 300) may filter the signal (or data) to be transmitted to the satellite network based on the data filter information. For example, if there is a signal (or data) to be transmitted to the satellite network, the first processor 300 may identify whether the transmission of the corresponding signal (or data) to the satellite network is possible based on the data filter information. For example, when at least one of the type of the signal (or data) to be transmitted to the satellite network or the type of the communication function is included in the data filter information, the first processor 300 may determine that the corresponding signal (or data) is transmissible to the satellite network.

For example, when the first processor 300 determines that the corresponding signal (or data) is transmissible to the satellite network, the first processor 300 may transmit the signal (or data) for transmission to the satellite network to the second processor 302. The second processor 302 may control the communication circuit 304 to transmit the signal (or data) received from the first processor 300 to the satellite network.

According to an embodiment, when at least one of the type of the signal (or data) to be transmitted to the satellite network and the type of the communication function is not included in the data filter information, the first processor 300 may determine that the corresponding signal (or data) is restricted from being transmitted to the satellite network. For example, at least one of the type of the signal (or data) to be transmitted to the satellite network or the type of the communication function may be identified based on at least one of a port or an IP address related to the signal (or data) for transmission to the satellite network.

According to an embodiment, when it is determined that the transmission of the corresponding signal (or data) to the satellite network is limited, the first processor 300 may limit the transmission of the signal (or data) to the second processor 302 for transmission to the satellite network. According to an embodiment, if the signal (or data) to be transmitted to the satellite network is not acquired (or received) from the first processor 300, the second processor 302 may operate in an inactive state. If the second processor 302 acquires (or receives) the signal (or data) to be transmitted to the satellite network from the first processor 300 while in an inactive state, the second processor 302 may operate in (or switch to) an active state. For example, the inactive state of the second processor 302 may be a state in which the operation of the second processor 302 is limited or suspended such that the power (or current) consumption by the second processor 302 is minimized and/or reduced, and may include a low-power state (e.g., a sleep state) or a standby state (e.g., an idle state).

According to an embodiment, when the electronic device 101 (e.g., the first processor 300) generates data filter information related to the satellite network based on specified communication restriction information, the electronic device 101 may update the data filter information based on the communication restriction information acquired from the satellite network. For example, when the first processor 300 generates data filter information related to the satellite network based on specified communication restriction information, the first processor 300 may identify whether the communication restriction information is received from the satellite network. For example, when the first processor 300 has acquired the communication restriction information received from the satellite network through the second processor 302, the first processor 300 may update data filter information based on the communication restriction information received from the satellite network. For example, if the communication restriction information is not received from the satellite network, the first processor 300 may maintain data filter information generated based on the specified communication restriction information.

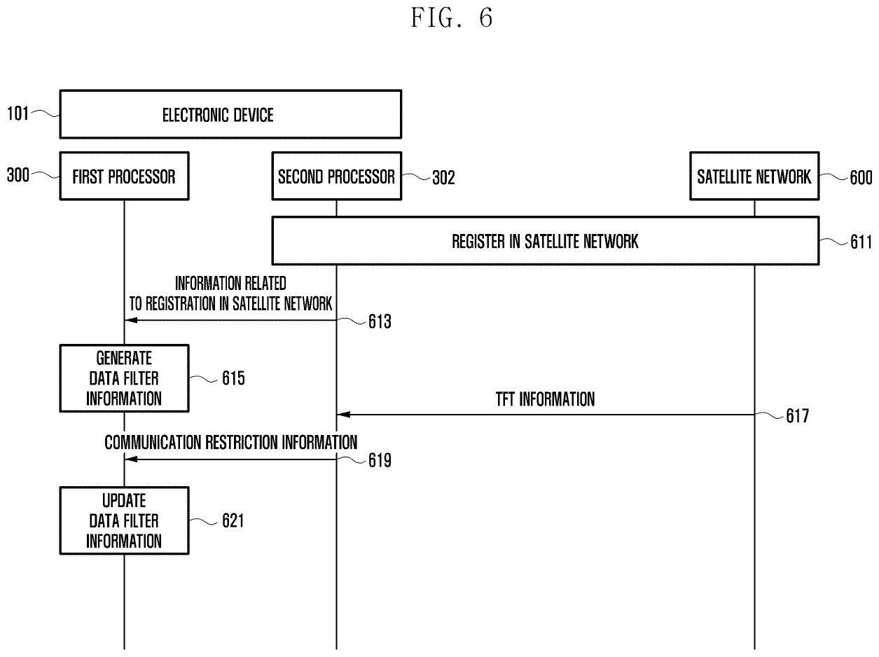

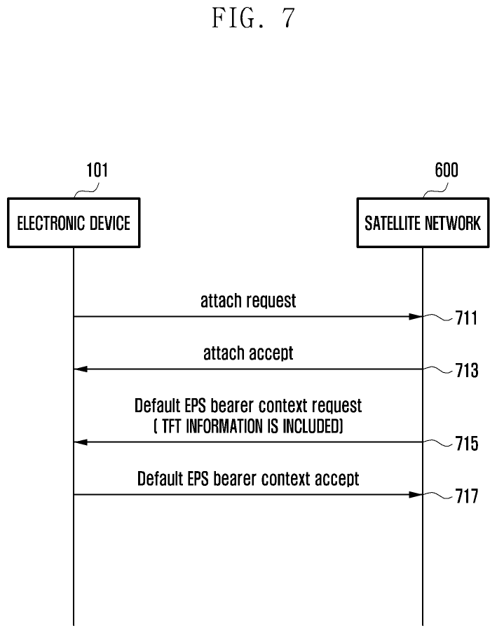

FIG. 6 is a signal flow diagram illustrating example operations of filtering data communication in an electronic device according to various embodiments. FIG. 7 is a signal flow diagram illustrating example operations for acquiring communication restriction information in an electronic device according to various embodiments.

According to an embodiment referring to FIGS. 6 and 7, the electronic device 101 (e.g., the second processor 302) may perform registration in a satellite network 600 (operation 611). For example, the second processor 302 may control the communication circuit 304 to register the electronic device 101 in the satellite network 600 through a satellite (e.g., the non-terrestrial wireless communication device 200 of FIG. 2) in which the electronic device 101 is connected. For example, registration in the satellite network 600 may include a series of operations in which the electronic device 101 transmits an attach request message (operation 711 in FIG. 7) through a satellite, and receives an attach accept message (operation 713 in FIG. 7) from the satellite. For example, the access to the satellite may be performed through a random access channel (RACH) procedure.

For example, the second processor 302 may determine that the electronic device 101 is registered in the satellite network if the information on the network in which the electronic device 101 is registered is included in the specified PLMN information. For example, the network information may include at least one of an MCC or an MNC. For example, the second processor 302 may identify the registration in the satellite network based on the control information (e.g., SIB19) acquired (or received) from the network in which the electronic device 101 is registered.

According to an embodiment, when it is determined that the electronic device 101 is registered in the satellite network 600, the second processor 302 may transmit information related to registration in the satellite network 600 to the first processor 300 (operation 613).

According to an embodiment, when the first processor 300 acquires, from the second processor 302, information related to registration in the satellite network 600, the first processor 300 may determine that the electronic device 101 is registered in the satellite network 600.

According to an embodiment, the first processor 300 may identify whether communication restriction information has been acquired from the satellite network 600. If the first processor 300 has not acquired the communication restriction information from the satellite network 600, the first processor 300 may generate data filter information related to the satellite network based on the specified communication restriction information (operation 615). For example, the specified communication restriction information is communication restriction information stored in the memory 306, and may include at least one of communication restriction information configured at the time of release of the electronic device 101 or communication restriction information acquired from the satellite network at a previous time. For example, the data filter information may include information related to at least one of the data type determined to be supported in the satellite network or the types of communication functions. For example, at least one of the data type supported in the satellite network or the types of communication functions may be identified based on at least one of a port (e.g., a port or a local port) related to data transmission, an IP version, or an Internet Protocol (IP) address.

According to an embodiment, the second processor 302 may acquire communication restriction information from the satellite network 600 (operation 617). For example, the second processor 302 may acquire communication restriction information from a “Default EPS Bearer context request” message received from the registered satellite network 600 in which the electronic device 101 is registered (operation 715 in FIG. 7). The second processor 302 may transmit a “default EPS bearer context accept” message to the satellite network 600 as a response to the “default EPS bearer context request” message (operation 717 of FIG. 7). For example, the communication restriction information may include a traffic filter template (TFT).

According to an embodiment, the second processor 302 may transmit the communication restriction information acquired from the satellite network 600 to the first processor 300 (operation 619). For example, the communication restriction information transmitted to the first processor 300 may be modified (or edited) to correspond to the first processor 300.

According to an embodiment, when the first processor 300 has acquired the communication restriction information acquired from the satellite network 600 through the second processor 302, the first processor 300 may update the data filter information related to the satellite network 600 (operation 621). For example, the update of the data filter information may include at least one of addition of a new data type or a type of communication function supported by the satellite network 600 or deletion of a data type or a type of communication function not supported by the satellite network 600. For example, the addition of a new type of data or a type of communication function may include a series of operations of adding at least one of a port, an IP version, or an IP address related to the new type of data or the type of communication function in data filter information. For example, the deletion of a type of data or a type of communication function may include a series of operations of deleting at least one of a port, an IP version, or an IP address related to the type of data or the type of communication function determined to be unsupported by the satellite network 600 in the data filter information.

According to an embodiment, the first processor 300 may filter a signal (or data) for transmission to the satellite network 600 based on the data filter information related to the satellite network 600. For example, when there is a signal (or data) to be transmitted to the satellite network 600, the first processor 300 may identify whether the signal (or data) is transmittable to the satellite network 600 based on the data filter information. When the first processor 300 determines that the corresponding signal (or data) is transmissible to the satellite network, the first processor 300 may transmit the signal (or data) for transmission to the satellite network to the second processor 302. The second processor 302 may control the communication circuit 304 to transmit the signal (or data) received from the first processor 300 to the satellite network. For example, when it is determined that the transmission of the corresponding signal (or data) to the satellite network is limited, the first processor 300 may limit the transmission of the signal (or data) for transmission to the satellite network to the second processor 302.

According to an embodiment, the electronic device 101 (e.g., the first processor 300) may generate data filter information related to the satellite network 600 based on communication restriction information acquired from the satellite network. For example, when the second processor 302 is registered in the satellite network 600 and has acquired the communication restriction information from the satellite network 600 (e.g., operations 711 to 717 in FIG. 7), the second processor 302 may transmit, to the first processor 300, information related to the registration in the satellite network 600, which includes the communication restriction information acquired from the satellite network 600. The first processor 300 may generate the data filter information related to the satellite network 600 based on the communication restriction information acquired from the satellite network 600.

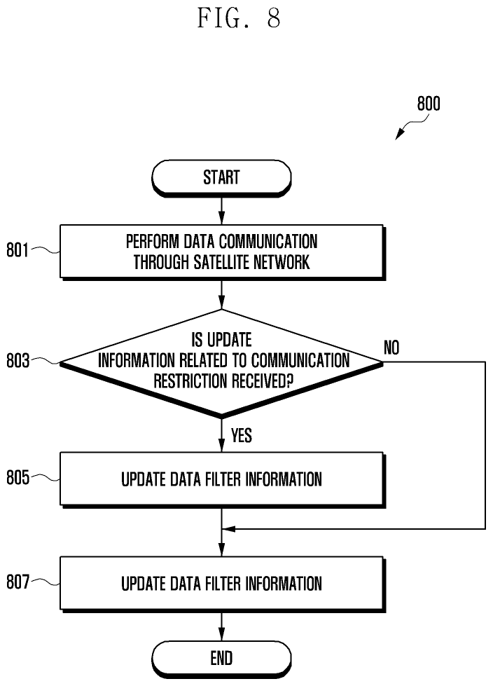

FIG. 8 is a flowchart 800 illustrating example operations for updating filter information related to data communication in an electronic device according to various embodiments. According to an embodiment, at least a part of FIG. 8 may include a detailed description of operation 509 of FIG. 5. Each operation in the following embodiments may be performed in sequence, but is not necessarily performed in sequence. For example, the order of the operations may be changed, and at least two operations may be performed in parallel. For example, the electronic device of FIG. 8 may be the electronic device 101 of FIG. 1, FIG. 2, FIG. 3, or FIG. 4.

According to an embodiment referring to FIG. 8, in operation 801, the electronic device (e.g., the processor 120 of FIG. 1 or the first processor 300 of FIG. 3) may perform data communication through a registered satellite network in which the electronic device 101 is registered. For example, the first processor 300 may control at least one of the second processor 302 or the communication circuit 304 to perform data communication corresponding to the type of data supported by the satellite network or the type of communication functions through data filtering based on satellite network-related data filter information generated in operation 505 or operation 507 of FIG. 5.

According to an embodiment, in operation 803, the electronic device (e.g., the processor 120 or the first processor 300) may identify whether update information related to communication restriction is received from the satellite network while being registered in the satellite network. For example, the update information related to the communication restriction may be included in a modification request message and received from the satellite network.

According to an embodiment, when the electronic device (e.g., the processor 120 or the first processor 300) receives the update information related to the communication restriction from the satellite network (e.g., “Yes” in operation 803), in operation 805, the electronic device may update data filter information related to the satellite network based on the update information related to the communication restriction. For example, when the first processor 300 receives the update information related to the communication restriction from the second processor 302, the first processor 300 may add information (e.g., a port, an IP version, or an IP address) related to a type of new data or a type of communication function included in the update information related to the communication restriction to the data filter information. For example, when the first processor 300 receives the update information related to the communication restriction from the second processor 302, the first processor 300 may identify at least one of a type of data changed to be unsupported by the satellite network or a type of communication function in the update information related to the communication restriction. The first processor 300 may delete information (e.g., a port, an IP version, or an IP address) related to the type of data or the type of communication function that has been changed to be unsupported by the satellite network from the data filter information.

According to an embodiment, in operation 807, the electronic device (e.g., the processor 120 or the first processor 300) may filter a signal (or data) for transmission to the satellite network based on the updated data filter information, based on update information related to communication restrictions. For example, if there is a signal (or data) to be transmitted to the satellite network, the first processor 300 may identify whether the transmission of the corresponding signal (or data) to the satellite network is possible based on the data filter information. For example, when the first processor 300 determines that the corresponding signal (or data) is transmissible to the satellite network, the first processor 300 may transmit the signal (or data) for transmission to the satellite network to the second processor 302. The second processor 302 may control the communication circuit 304 to transmit the signal (or data) received from the first processor 300 to the satellite network.

For example, when the first processor 300 determines that the transmission of a signal (or data) for transmission to the satellite network is limited, the first processor 300 may limit the transmission of the signal (or data) for transmission to the satellite network to the second processor 302. For example, when the signal (or data) to be transmitted to the satellite network is not acquired (or received) from the first processor 300, the second processor 302 may operate in an inactive state. For example, the inactive state of the second processor 302 may be a state in which operation of the second processor 302 is limited or suspended and thus power (or current) consumption in the second processor 302 is minimized and/or reduced, and may include a low-power state (e.g., a sleep state) or a standby state (e.g., an idle state).

According to an embodiment, when the update information related to the communication restriction has not been received from the satellite network (e.g., “No” in operation 803), in operation 807, the electronic device (e.g., the processor 120 or the first processor 300) may filter a signal (or data) for transmission to the satellite network, based on the data filter information. For example, when the update information related to the communication restriction has not been received from the second processor 302, the first processor 300 may determine that the data filter information is maintained. If there is a signal (or data) to be transmitted to the satellite network, the first processor 300 may identify whether the transmission of the corresponding signal (or data) to the satellite network is possible based on the data filter information.

According to an example embodiment, an operating method performed by an electronic device (e.g., the electronic device 101 of FIG. 1, FIG. 2, FIG. 3, or FIG. 4) may include identifying whether communication restriction information is received from the satellite network through the communication processor (e.g., the processor 120, the auxiliary processor 123 of FIG. 1, or the second processor 302 of FIG. 3) when the application processor (e.g., the processor 120, the main processor 121 of FIG. 1, or the first processor 300 of FIG. 3) of the electronic device determines that the electronic device is registered in a satellite network. According to an embodiment, an operating method performed by an electronic device may include generating data filter information based on the specified restriction information stored in the electronic device when communication restriction information is not received from the satellite network. According to an embodiment, an operating method performed by an electronic device may include generating data filter information based on the communication restriction information received from the satellite network when communication restriction information is received from the satellite network. According to an embodiment, an operating method performed by an electronic device may include controlling data transmission to the communication processor, based on the data filter information.

According to an embodiment, an operating method performed by an electronic device may include performing a registration in the satellite network through the communication processor. According to an embodiment, an operating method performed by an electronic device may include transmitting information related to registration in the satellite network to the application processor when the communication processor determines that the electronic device is registered in the satellite network. According to an embodiment, an operating method performed by an electronic device may include determining that the electronic device is registered in the satellite network by the application processor, based on information related to the registration in the satellite network received from the communication processor.

According to an embodiment, controlling data transmission may include controlling data transmission to the communication processor, based on data filter information generated based on the specified communication restriction information, when the application processor has not received communication restriction information from the satellite network through the communication processor.

According to an embodiment, the data filter information may include information related to at least one of at least one data port or at least one Internet protocol (IP) allowing transmission to a satellite network.

According to an embodiment, controlling data transmission may include identifying, by an application processor, at least one of a port or an Internet protocol (IP) of data to be transmitted to the satellite network. According to an embodiment, controlling data transmission may include identifying whether the data is transmitted based on at least one of the port or the IP of the data and the data filter information. According to an embodiment, controlling data transmission may include transmitting the data to the communication processor when it is determined that the data is transmitted.

According to an embodiment, an operating method performed by an electronic device may include restricting transmission of the data to the communication processor when it is determined that the data is not transmitted by an application processor.

According to an embodiment, controlling data transmission may include controlling data transmission to the communication processor by the application processor through a kernel based on the data filter information.

According to an embodiment, an operating method performed by an electronic device may include identifying whether communication restriction information is received from the satellite network through the communication processor when data filter information is generated based on the specified restriction information by an application processor. According to an embodiment, an operating method performed by an electronic device may include updating the data filter information based on communication restriction information received from the satellite network when the communication restriction information is received from the satellite network. According to an embodiment, an operating method performed by an electronic device may include controlling data transmission to the communication processor based on the data filter information updated based on communication restriction information received from the satellite network.

According to an embodiment, an operating method performed by an electronic device may include updating the data filter information based on update information related to the communication restriction when the application processor receives the update information related to the communication restriction from the satellite network through a communication processor in a state of being registered in the satellite network. According to an embodiment, an operating method performed by an electronic device may include controlling data transmission to the communication processor based on the updated data filter information, based on update information related to communication restrictions.

According to example embodiments of the disclosure, the consumption of at least one of power (or current) or radio resources of an electronic device for transmission of unnecessary signals (or data) can be reduced by adaptively filtering the transmission of signals (or data) from the application processor (AP) of the electronic device to the satellite network, based on information related to the limited communication capabilities supported by the satellite network.

Advantageous effects obtainable from various embodiments of the disclosure may not be limited to the above-mentioned effects, and other effects which are not mentioned herein may be clearly understood from the following description by those skilled in the art to which various embodiments of the disclosure pertain.

The various example embodiments of the disclosure are examples presented to easily describe the technical contents according to the various example embodiments of the disclosure and to help understanding the various embodiments of the disclosure, and are not intended to limit the scope of the various embodiments of the disclosure. Therefore, the scope of the disclosure should be understood to include all changes or modified forms that may be derived from the technical idea of the disclosure, in addition to the various example embodiments disclosed herein. It will also be understood that any of the embodiment(s) described herein may be used in connection with any other embodiment(s) described herein.

What is claimed is:

1. An electronic device comprising:
a memory;
a communication circuit configured to support satellite communication;
at least one communication processor, comprising processing circuitry, operatively connected to the memory and the communication circuit; and
at least one application processor, comprising processing circuitry, operatively connected to the memory and at least one communication processor,
wherein at least one application processor, individually and/or collectively, is configured to cause the electronic device to:
based on determining that the electronic device is registered in a satellite network, identify whether communication restriction information is received from the satellite network through at least one communication processor;
based on communication restriction information not being received from the satellite network, generate data filter information, based on specified restriction information stored in the memory;
based on communication restriction information being received from the satellite network, generate data filter information, based on the communication restriction information received from the satellite network; and
control data transmission to at least one communication processor, based on the data filter information.

2. The electronic device of claim 1, wherein the data filter information includes information related to at least one of at least one data port and/or at least one Internet protocol (IP) allowing transmission to the satellite network.

3. The electronic device of claim 1, wherein at least one application processor, individually and/or collectively, is configured to cause the electronic device to:
identify at least one of a port or an Internet protocol (IP) of data for transmission to the satellite network;
based on at least one of the port or the IP of the data and the data filter information, identify whether to transmit the data; and
based on determining to transmit the data, transmit the data to at least one communication processor.

4. The electronic device of claim 3, wherein at least one application processor, individually and/or collectively, is configured to cause the electronic device to, based on determining to not transmit the data, restrict transmission of the data to at least one communication processor.

5. The electronic device of claim 1, wherein at least one communication processor, individually and/or collectively, is configured to cause the electronic device to:
acquire the communication restriction information from a control message received from the satellite network through the communication circuit; and
edit the communication restriction information to correspond to at least one application processor, and transmit the edited communication restriction information to at least one application processor.

6. The electronic device of claim 1, wherein at least one application processor, individually and/or collectively, is configured to cause the electronic device to control, through a kernel, the data transmission to at least one communication processor, based on the data filter information.

7. The electronic device of claim 1, wherein at least one application processor, individually and/or collectively, is configured to cause the electronic device to:
based on the data filter information being generated based on the specified restriction information, identify whether the communication restriction information is received from the satellite network through at least one communication processor;
based on the communication restriction information being received from the satellite network, update the data filter information, based on the communication restriction information received from the satellite network; and
control data transmission to at least one communication processor, based on the updated data filter information.

8. The electronic device of claim 1, wherein at least one application processor, individually and/or collectively, is configured to cause the electronic device to:
based on update information related to communication restriction being received from the satellite network through at least one communication processor in a state where the electronic device is registered in the satellite network, update the data filter information, based on the update information related to communication restriction; and
control data transmission to at least one communication processor, based on the updated data filter information.

9. A method of operating an electronic device, the method comprising:
based on determining that the electronic device is registered in a satellite network, identifying, by at least one application processor of the electronic device, whether communication restriction information is received from the satellite network through at least one communication processor of the electronic device;
based on communication restriction information not being received from the satellite network, generating data filter information, based on specified restriction information stored in the electronic device;
based on communication restriction information being received from the satellite network, generating data filter information, based on the communication restriction information received from the satellite network; and
controlling data transmission to at least one communication processor, based on the data filter information.

10. The method of claim 9, wherein the controlling of the data transmission comprises:
identifying, by at least one application processor, at least one of a port or an Internet protocol (IP) of data for transmission to the satellite network;
identifying whether to transmit the data, based on at least one of the port or the IP of the data and the data filter information; and
based on determining to transmit the data, transmitting the data to at least one communication processor.

11. The method of claim 10, further comprising, based on determining to not transmit the data, restrict, by at least one application processor, transmission of the data to at least one communication processor.

12. The method of claim 9, wherein the communication restriction information received from the satellite network includes a traffic filter template (TFT) received from the satellite network.

13. The method of claim 9, wherein the controlling of the data transmission comprises controlling data transmission to at least one communication processor by at least one application processor through a kernel, based on the data filter information.

14. The method of claim 9, further comprising:
based on the data filter information being generated based on the specified restriction information, identifying, by at least one application processor, whether the communication restriction information is received from the satellite network through at least one communication processor;
based on the communication restriction information being received from the satellite network, updating the data filter information, based on the communication restriction information received from the satellite network; and
controlling the data transmission to at least one communication processor, based on the updated data filter information.

15. The method of claim 9, further comprising:
based on update information related to communication restriction being received from the satellite network through at least one communication processor in a state where the electronic device is registered in the satellite network, updating, by at least one application processor, the data filter information, based on the update information related to communication restriction; and
controlling the data transmission to at least one communication processor, based on the updated data filter information.

16. The method of claim 9, wherein the data filter information includes information related to at least one of at least one data port and/or at least one Internet protocol (IP) allowing transmission to the satellite network.

17. A non-transitory computer-readable medium storing instructions which, when executed by at least one application processor of an electronic device, cause the electronic device to perform operations comprising:
based on determining that the electronic device is registered in a satellite network, identifying, by at least one application processor of the electronic device, whether communication restriction information is received from the satellite network through at least one communication processor of the electronic device;
based on communication restriction information not being received from the satellite network, generating data filter information, based on specified restriction information stored in the electronic device;
based on communication restriction information being received from the satellite network, generating data filter information, based on the communication restriction information received from the satellite network; and
controlling data transmission to at least one communication processor, based on the data filter information.

18. The non-transitory computer-readable storage media of claim 17, further comprising:
identifying, by at least one application processor, at least one of a port or an Internet protocol (IP) of data for transmission to the satellite network;
identifying whether to transmit the data, based on at least one of the port or the IP of the data and the data filter information; and
based on determining to transmit the data, transmitting the data to at least one communication processor.

19. The non-transitory computer-readable storage media of claim 17, further comprising: based on determining to not transmit the data, restrict, by at least one application processor, transmission of the data to at least one communication processor.

20. The non-transitory computer-readable storage media of claim 17, further comprising: controlling data transmission to at least one communication processor by at least one application processor through a kernel, based on the data filter information.
